(19) United States
(12) Patent Application Publication
(10) Pub. No.: US 2025/0365629 A1
(43) Pub. Date: Nov. 27, 2025

(54) REDUCED UP INTERRUPTION FOR INTER DISTRIBUTED UNIT LOWER LAYER MOBILITY WITH PING-PONGS

(71) Applicant: Nokia Technologies Oy, Espoo (FI)

(72) Inventors: Subramanya CHANDRASHEKAR, Bangalore (IN); Srinivasan SELVAGANAPATHY, Bangalore (IN); Ahmad AWADA, Munich (DE); Amaanat ALI, Espoo (FI); Panagiotis SPAPIS, Munich (DE)

(21) Appl. No.: 18/874,736

(22) PCT Filed: Mar. 22, 2023
(86) PCT No.: PCT/EP2023/057357

§ 371 Date: Dec. 13, 2024

(30) Foreign Application Priority Data
Jun. 14, 2022 (IN) 202241034028

(51) Int. Cl. H04W 36/18

(52) U.S. Cl. CPC H04W 36/18

(57) ABSTRACT

In accordance with example embodiments of the invention there is at least a method and apparatus to perform establishing, by a user equipment configured to support parallel reception of data from two cells belonging to different network nodes of a radio access network a connection towards a serving cell supported by a first network node supporting at least one of distributed unit functionality or the layer 2 protocol of the radio access network, and receiving data from the serving; transmitting a layer 1 measurement report including an indication of a second cell supported by a second network node and related measurement information towards the serving to enable the first network node to monitor lower layer mobility conditions, wherein the second network node supports at least one of distributed unit functionality or the layer 2 protocol of the radio access network; and receiving a layer 2 message including instructions for a cell change to the second cell, wherein the layer 2 message further comprises instructions to execute parallel reception from both the serving and the second cell at least during the cell change, and to retain at least one configuration for at least one of data transmission or reception with the serving after success of the cell change to the second cell.

### TECHNICAL FIELD

The teachings in accordance with the exemplary embodiments of this invention relate generally to reducing interruption for cell change operations and, more specifically, relate to reducing interruption for inter distributed unit lower layer mobility with ping-pong operations.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
CE control element
CU central unit
CU-CP central unit control plane
CU-UP centralized unit user plane
DAPS dual active protocol stack
DU distributed unit
gNB base station
HO handover
L1 layer 1
L2 layer 2
LLM lower layer mobility
MAC medium access control
MAC CE medium access control control element
mTRP multiple transmit/receive point
NR new radio
NR-CGI new radio cell global identification
PDCP packet data convergence protocol
PDU protocol data unit
RACH random access channel
RAN random access network
RRC radio resource control
RRM radio resource management
SCC serving cell change.
TAC tracking area code
PS protocol stack
UE user equipment
UP user plane

At the time of this application, a disaggregated architecture as shown in FIG. 1 is defined in 3GPP decomposing the gNB into multiple logical entities. Likewise, a single DU may host multiple cells (max of 512 in specifications). The gNB-CU-CP hosts the PDCP and RRC layers, while the gNB-DU hosts the RLC/, MAC and PHY layers. The scheduling operation takes place at the gNB-DU.

Standard releases, at the time of this application (hereafter as may be referred to as “current”) are limited to intra-DU mTRP operation to support transmission and reception of multiple beams from different cells, there is significant operator and vendor demand to continue further work in coming standards releases with a broader scope and likely to be agreed as well. This would extend the support also for change of serving-cell via L1/L2 based mechanisms in both intra-DU and inter-DU scenarios. FIG. 2 shows L1/L2 centric inter-cell mobility scenarios.

In order to support L1/L2 centric inter-cell change (i.e. change of serving cell) in the disaggregated gNB architecture, a new mechanism is seen to be needed in which configuration would take place at the gNB-CU-CP, but executed autonomously by the gNB-DU without further interaction with the upper layers.

Example embodiments of the invention as disclosed herein work to address at least these requirements.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows disaggregated gNB architecture;

FIG. 2 shows L1/L2 centric inter-cell mobility scenarios;

FIG. 3 shows an LLM inter DU scenario;

FIG. 4 shows low layer mobility capturing data forwarding;

FIG. 5A and FIG. 5B shows a message exchange with reduced UP interruption and DAPS/mTRP interworking in accordance with example embodiments of the invention;

FIG. 6 shows a high level block diagram of various devices used in carrying out various aspects of the invention; and

FIG. 7A, FIG. 7B, FIG. 7C, FIG. 7D, and FIG. 7E each show a method in accordance with example embodiments of the invention which may be performed by an apparatus;

FIG. 8 shows a message exchange with reduced UP interruption and without DAPS/mTRP being configured in accordance with example embodiments of the invention.

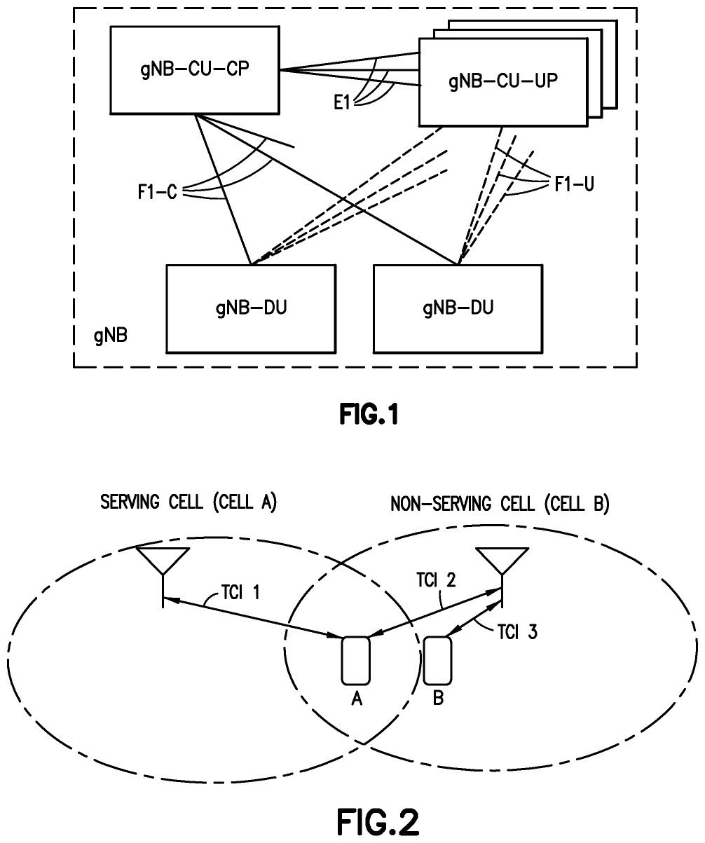

### DETAILED DESCRIPTION

In example embodiments of the invention as disclosed herein there is proposed operations and apparatus for reducing interruption for inter distributed unit lower layer mobility with ping-pong operations.

As similarly stated above, in order to support L1/L2 centric inter-cell change (i.e. change of serving cell) in the disaggregated gNB architecture, a new mechanism is needed in which configuration would take place at the gNB-CU-CP, but executed autonomously by the gNB-DU without further interaction with the upper layers.

This includes two aspects:
a. Multi TRP operation involving serving and assisting cells, both intra-DU and inter-DU scenarios; and
b. L1/L2 centric inter-cell change, both intra-DU and inter-DU scenarios.

Some definitions used herein are as follows:
mTRP operation: Simultaneous DL/UL transmission in serving and assisting cell TRPs;
Assisting cell: A non-serving cell which is used to assist a UE in multi-TRP operation. It may belong to the same DU or different DU hosting the serving cell, but has to belong to the same gNB-CU; and
DAPS: Dual Active Protocol Stack, defined as part of current standards.

Some objectives of current standards include:
1. To specify mechanism and procedures of L1/L2 based inter-cell mobility for mobility latency reduction:
Configuration and maintenance for multiple candidate cells to allow fast application of configurations for candidate cells [RAN2, RAN3],
Dynamic switch mechanism among candidate serving cells (including SCells) for the potential applicable scenarios based on L1/L2 signaling [RAN2, RAN1],
L1 enhancements for inter-cell beam management, including L1 measurement and reporting, and beam indication [RAN1, RAN2]:
Note 1: Early RAN2 involvement is necessary, including the possibility of further clarifying the interaction between this bullet with the previous bullet,
Timing Advance management [RAN1, RAN2],
CU-DU interface signaling to support L1/L2 mobility, if needed [RAN3]:
Note 2: FR2 specific enhancements are not precluded, if any,
Note 3: The procedure of L1/L2 based inter-cell mobility are applicable to the following scenarios:
Standalone, CA and NR-DC case with serving cell change within one CG,
Intra-DU case and intra-CU inter-DU case (applicable for Standalone and CA: no new RAN interfaces are expected),
Both intra-frequency and inter-frequency,
Both FR1 and FR2, and
Source and target cells may be synchronized or non-synchronized

Further notes:
Lower layer mobility is a mobility feature and can be considered a basic UE capability (starting R18),
DAPS and mTRP operation are two other different functionalities and hence they have different UE capabilities, and
It is quite a possible scenario where a UE is capable of LLM, but not capable of mTRP or DAPS.

Some objectives of example embodiments of the invention may include:
Providing un-interrupted data transmission during inter-DU LLM and/or
Enabling lower layer mobility procedure to meet stringent requirements of low interruption time in certain use cases (e.g., AR/XR, URLLC), where interruption time of 5-10 ms is foreseen.

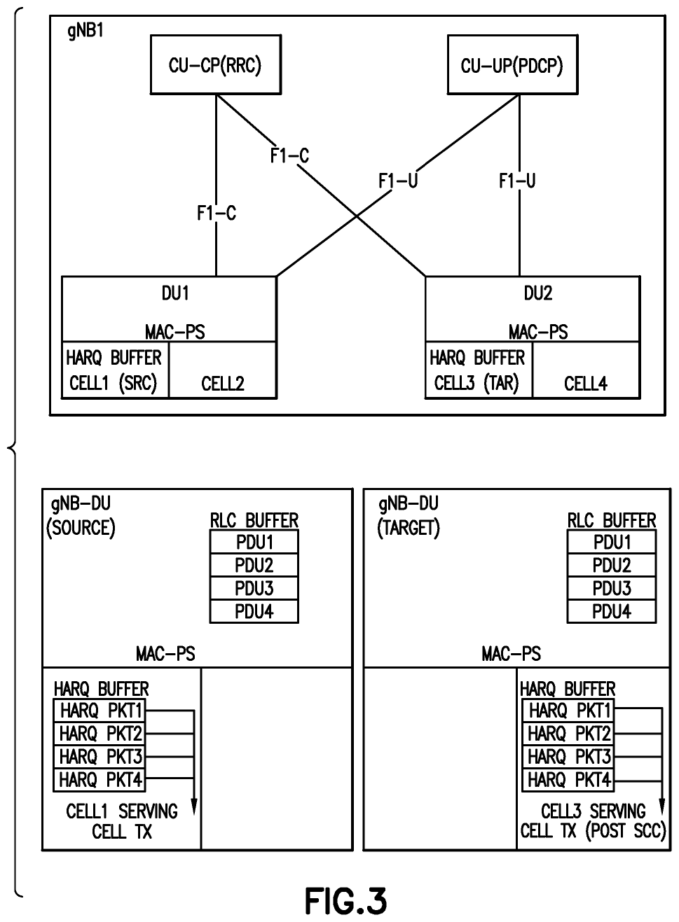

FIG. 3 shows an LLM inter DU scenario. In the scenario as in FIG. 3 there is:
DL transmission at source DU (controlling serving cell 1),
Target cell (non-serving cell) (cell 3) configured as one of the LLM prepared cells at both, DU(s) and UE,
UE reporting L1 measurements to serving DU, and
Based on the conditions configured for LLM, serving DU issues a MAC CE to the UE to perform serving cell change (SCC) and random access (if needed in non-synchronized scenarios) to target cell.

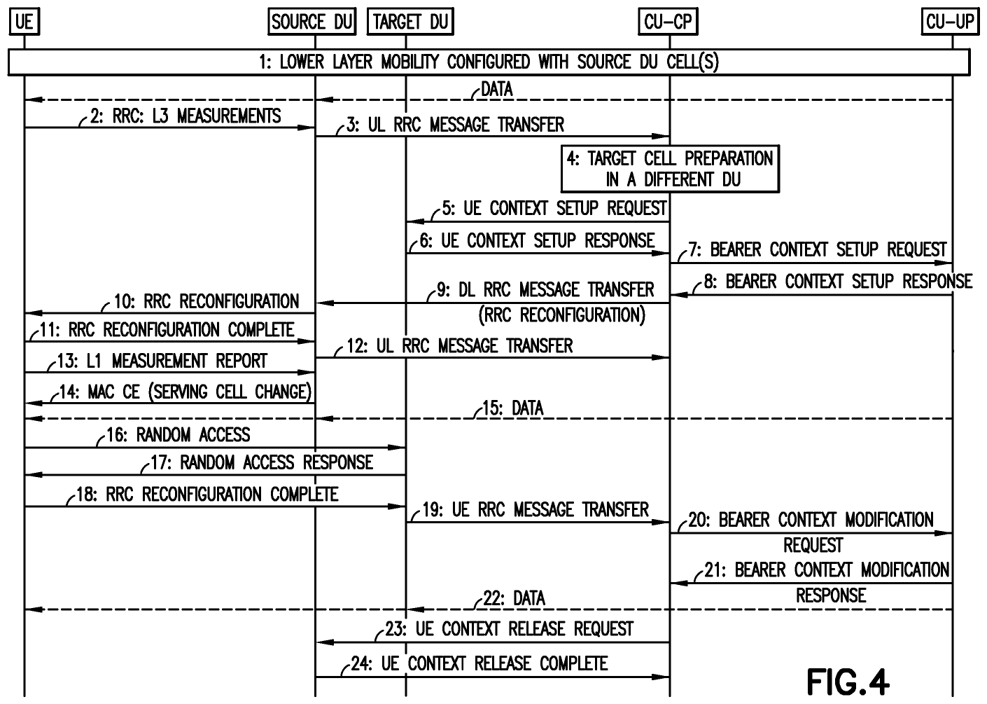

FIG. 4 shows low layer mobility capturing data forwarding according to current standards.

FIG. 4 shows signaling diagram for inter-DU lower layer mobility procedure, including the data forwarding to the UE from both Source cell (before the cell change in step 14) and Target cell (after the cell change).

Problems of the current standards include:
There is a UP interruption during SCC from Source cell (Cell 1) to Target cell (Cell 3) i.e., from step 14 to step 22 as in FIG. 4 such delay may be unacceptable for some services like the ones described above, and.
Once LLM HO is executed, the CU needs to perform bearer modification so as to enable data transmission to the UE from the Target (now serving) DU.

Example embodiments of the invention as disclosed herein aims to at least reduce the user plane interruption during the execution of LLM.

There are some L3 based mechanisms which are potentially suited to reduce user plane interruption, but require significant additional signaling, some of which are listed below.
1—Make-before-break of LTE,
2—RACH-less HO,
3—DAPS handover (along with early data forwarding),
4—Single active protocol stack handover (UE performs random access to target cell while receiving from source cell and when it receives RACH response, the UE detaches from source cell and sends RRC complete to target cell),
5—DC based HO, and
6—Add target gNB as SN, do later swap role, and then release the SN (which is the old source gNB).

However, it is noted that there seems no known prior-art in reducing user-plane interruption during LI mobility. It is also important to note that the above listed mechanisms cannot be used as it is for LLM.

Further, in 5G (e.g. due to topology of network enabled to support/provide multiple different services and with high amount of overlapping 5G cells/small cells/mm-wave beams, etc.) an increasing number of ping-pongs can be a result. The ping-pongs can be based on inadvertent consecutive handovers to cells of the plurality of cells within a time period. In 5G technology, the use of mm-waves is the predominant factor affecting mobility. This occurs due to the high path loss when mm-wave frequency bands are employed thereby the cell coverage reduces. Leading to a significant increase in the handover probabilities, which leads to increased mobility problems, such as high handover failure, handover Ping-Pong effect, and radio link failures.

Example embodiments of the invention address e.g.:
To address the user-plane interruption issue by complimenting early detection of lower-layer mobility at the source DU and with early data transmission to the target DU and/or
To address the ping-pong issue (consecutive forth and back handover to same cells or any other cells in certain time limit, e.g., 3 seconds) by creating and storing a mapping table at CU-UP to identify the UE and its configuration in a given DU/cell, as long as ping-pong is a possibility. The user configuration may also be retained at the DU during that duration:
The mapping table at CU-UP is created based on the inputs from CU-CP. It associates a UE with its configuration in the gNB. For example: A UE configured with multi-TRP operation may include the UE ID, configured service (mTRP), serving and assisting cells in each DU served by the CU-UP etc., and
This enables the CU-UP to decide whether or not the connection to old source cell is available at the time of starting data transmission.

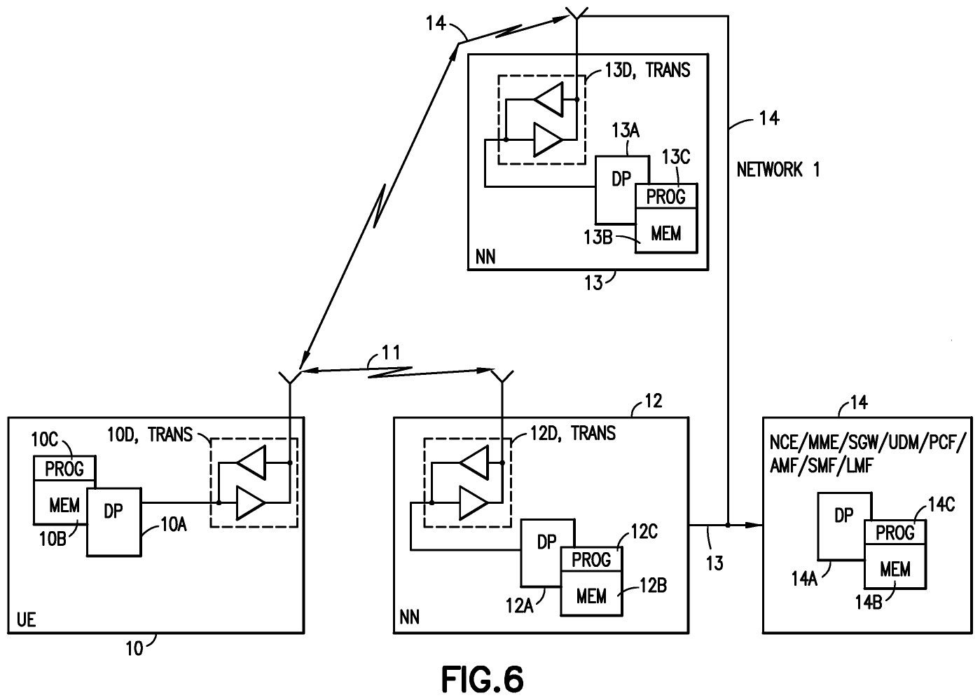

Before describing the example embodiments of the invention in detail, reference is made to FIG. 6 for illustrating a simplified block diagram of various electronic devices that are suitable for use in practicing the example embodiments of this invention.

FIG. 6 shows a block diagram of one possible and non-limiting exemplary system in which the example embodiments of the invention may be practiced. In FIG. 6, a user equipment (UE) 10 is in wireless communication with a wireless network 1 or network, 1 as in FIG. 6. The wireless network 1 or network 1 as in FIG. 6 can comprise a communication network such as a mobile network e.g., the mobile network 1 or first mobile network as disclosed herein. Any reference herein to a wireless network 1 as in FIG. 6 can be seen as a reference to any wireless network as disclosed herein. Further, the wireless network 1 as in FIG. 6 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11 or 14.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 6. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments of the invention. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 14. Further, the link 11, link 14 and/or any other link may be wired or wireless or both and may implement, e.g., an X2 or Xn interface. Further the link 11 and/or link 14 may be through other network devices such as, but not limited to an NCE/MME/SGW/UDM/PCF/AMF/SMF/LMF 14 device as in FIG. 6. The NN 12 may perform functionalities of an MME (Mobility Management Entity) or SGW (Serving Gateway), such as a User Plane Functionality, and/or an Access Management functionality for LTE and similar functionality for 5G.

The NN 13 can be associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments of the invention. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 14 or another link. The Link 14 as shown in FIG. 6 can be used for communication between the NN 12 and the NN 13. These links maybe wired or wireless or both and may implement, e.g., an X2 or Xn interface. Further, as stated above the link 11 and/or link 14 may be through other network devices such as, but not limited to an NCE/MME/SGW device such as the NCE/MME/SGW/UDM/PCF/AMF/SMF/LMF 14 of FIG. 6.

The one or more buses of the device of FIG. 6 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 6 shows a network nodes such as NN 12 and NN 13, any of these nodes may can incorporate or be incorporated into an eNodeB or eNB or gNB such as for LTE and NR, and would still be configurable to perform example embodiments of the invention.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments of the invention in any of an LTE, NR, 5G and/or any standards based communication technologies being performed or discussed at the time of this application. In addition, it is noted that the operations in accordance with example embodiments of the invention, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/WI/F(s)), interconnected through one or more buses coupled with the link 13 and/or link 14. In accordance with the example embodiments these network interfaces can include X2 and/or Xn interfaces for use to perform the example embodiments of the invention. The one or more memories MEM 14B include computer program code PROG 14C. The one or more memories MEM 14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments of the invention.

It is noted that that the NN 12 and/or NN 13 and/or UE 10 can be configured (e.g. based on standards implementations etc.) to perform functionality of a Location Management Function (LMF). The LMF functionality may be embodied in either of the Content Consumer A, Content Consumer B, Dash Server, and/or Content Provider or may be part of these network devices or other devices associated with these devices. In addition, an LMF the such as LMF of the MME/SGW/UDM/PCF/AMF/SMF/LMF 14 of FIG. 6, as at least described below, can be co-located with UE 10 such as to be separate from the NN 12 and/or NN 13 of FIG. 6 for performing operations in accordance with example embodiments of the invention as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

As similarly stated above, example embodiments of the invention address e.g.:
To address the user-plane interruption issue by complimenting early detection of lower-layer mobility at the source DU and with early data transmission to the target DU, and/or
To address the ping-pong issue (consecutive forth and back handover to same cells in certain time limit, e.g., 3 seconds) by creating and storing a mapping table at CU-UP to identify the UE and its configuration in a given DU/cell, as long as ping-pong is a possibility. The user configuration may also be retained at the DU during that duration.

The mapping table at CU-UP is created based on the inputs from CU-CP. It associates a UE with its configuration in the gNB. For example: A UE configured with multi-TRP operation may include the UE ID, configured service (mTRP), serving and assisting cells in each DU served by the CU-UP etc., and

This enables the CU-UP to decide whether or not the connection to old source cell is available at the time of starting data transmission.

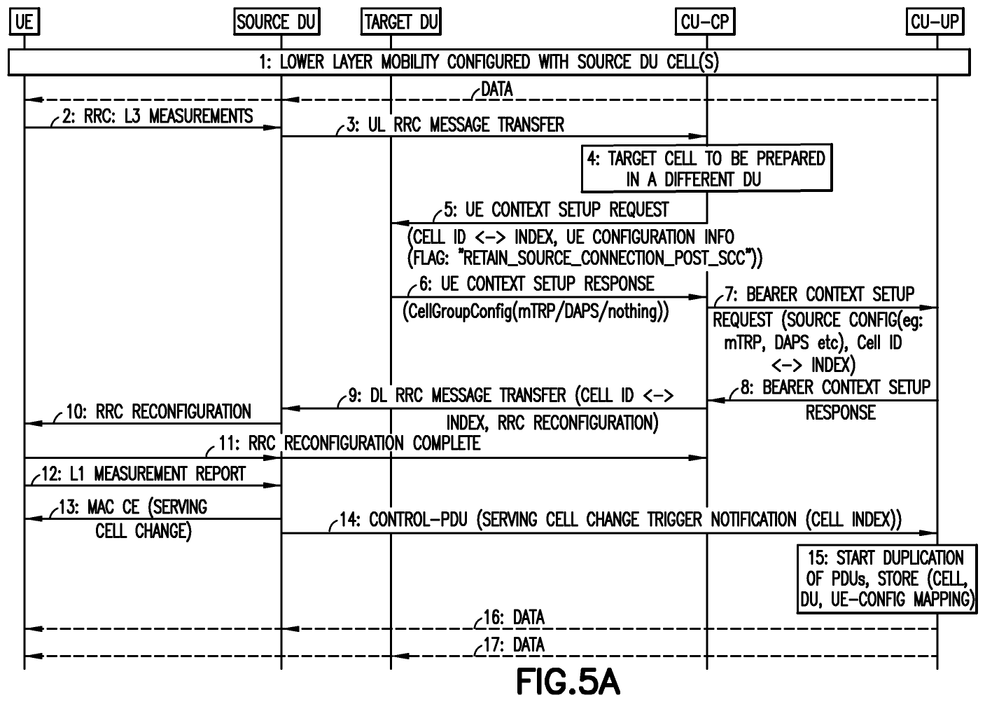

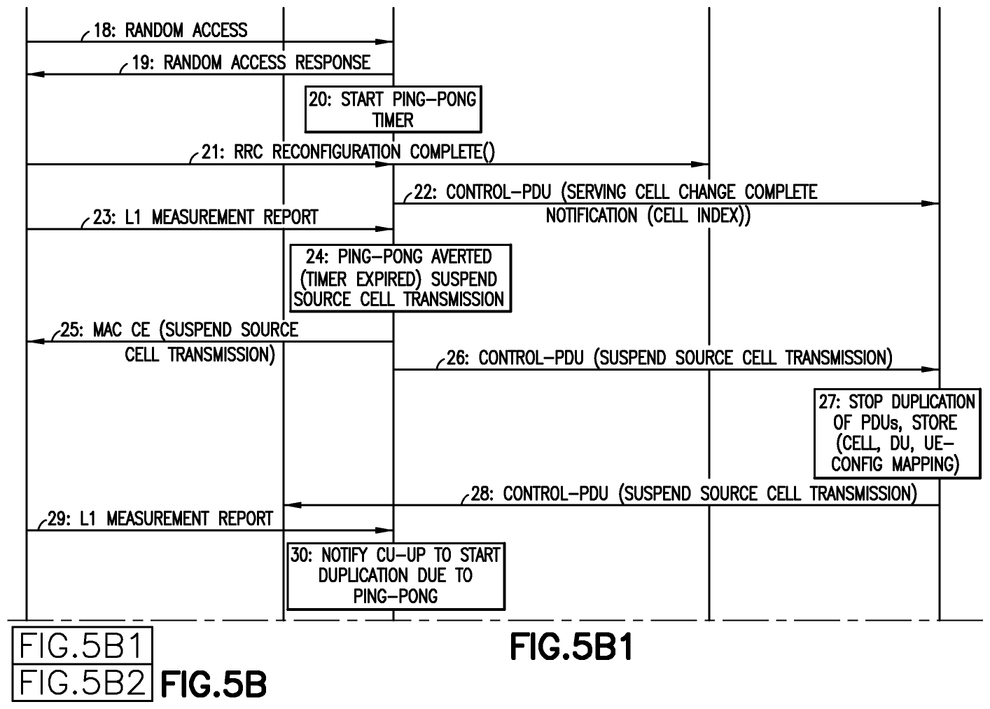

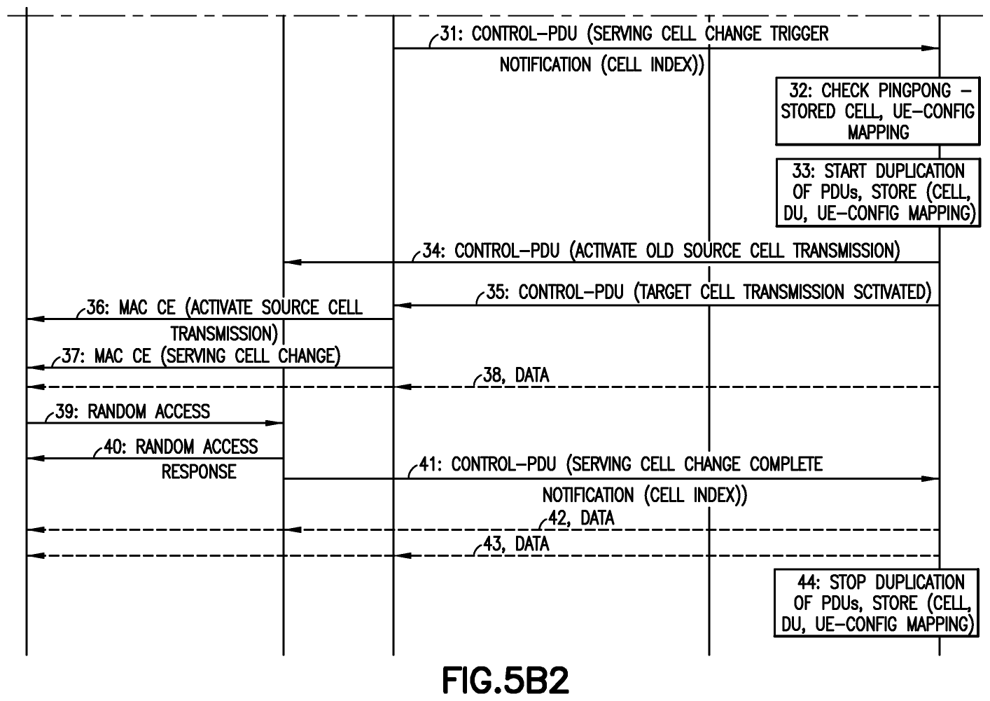

Though this can be a matter of implementation detail one principle is that both forward and reverse paths (e.g. cell change ping-pongs back and forth) could be covered, in this case the CU-UP stores the mapping of source and target paths and is able to duplicate in both the legs based on the indication from CU-CP. Therefore, once the source cell/DU gets the serving cell again (after step 39 as in FIG. 5B) in principle steps 29 to 37 as in FIG. 5B follow similarly using the cell ID index configure in step 9 as in FIG. 5A to address the CU-UP. FIG. 5A and FIG. 5B show a message exchange with reduced UP interruption and parallel data paths (e.g. based on DAPS/mTRP support of UE) in accordance with example embodiments of the invention.

More specifically elements of example embodiments of the invention may include at least one of:
UE is configured to keep the source cell configuration after receiving LLM switching (step 13) and also capable of receiving packets via source configuration until the source configuration is released (and/or a ping-pong timer expired).
Before or after sending MAC CE command for LLM SCC, the serving DU sends a control-PDU to CU-UP to initiate duplicate transmission of packets at serving and target DU (e.g. steps 13 and 14, or steps 31 and 36). This is decided based on RRM defined thresholds, configured by CU-CP or DU. The Control-PDU may also indicate (via in index), the exact target DU and cell to which the data transmission is to be started,
Indication of SCC switch from DU to CU-UP:
After or before sending MAC CE for LLM SCC, serving DU sends a control-PDU to indicate UE serving cell change initiation. CU-UP may start duplication of PDCP PDUs at this point also (e.g. step 15, or step 33),
Serving DU will maintain the lower layer configurations after sending the MAC command for LLM switch. If the UE indicate that RACH access is needed for the switch, source DU can continue with current TCI for scheduling as TCI switch will be effective only after RACH. PDCCH using old TCI will be stopped when switching notification is received from CU-CP, and
Target DU can be determined based on the RACH,
After a successful RACH, the target DU sends a control-PDU to CU-UP to indicate serving cell change completion (e.g. step 22).

### NOTE:

If mTRP or DAPS is configured for the UE during this serving cell change duration or if the UE is supporting DAPS and/or mTRP operation, UE can receive simultaneously from both serving and target cell leading to almost zero user-interruption time (e.g. steps 16 and 17), or
if the UE is not configured with mTRP or DAPS owing to UE capability limitations, the user-service interruption is reduced and the SCC is faster in case of a ping-pong since the F1-U tunnel to the serving DU is not released during this time.
The source cell connection is retained (at CU-UP, DU and UE) as long as the ping-pong is a possibility. This is e.g. determined based on the UE measurements:
CU-UP stores the configuration of a UE in a given target cell,
If there is a ping-pong, the new SRC (old target) sends a control-PDU to indicate UE serving cell change initiation (e.g. step 31),
CU-UP may start duplication of PDCP PDUs to the new TRC (old source) by activating the old source connection which was deactivated after the duplication of data was stopped previously (e.g. steps 33 and 34),
Target cell ID index is indicated in the control-PDU so that CU-UP can determine whether or not it can start duplication for a given UE in a given cell (based on mapping stored),
If after the serving cell change from source cell to target cell, the UE did not return to the source cell within a timer (needed for ping-pong detection, e.g., 1 s or 3s), the old serving DU can inform the CU-UP to release the UE context of source cell from the mapping table (e.g. step 26).
Step 5 of FIG. 5A is preparation of target cell in target DU in accordance with example embodiments of the invention. Hence, it is from CU-CP to target DU. in step 5 of FIG. 5A the UE context setup request message may include at least one of the following:
Cell ID index (to enable triggering of duplication of PDUs, suspend source cell transmission, etc.), and
UE configuration info (with info/flag: “retain source connection config after SCC (serving cell change, handover) (->to be forwarded to UE in case of handover to target DU).

It is noted that the info/flag: “retain source connection config after SCC (serving cell change, handover) may be forwarded to the UE in step 10 included in the RRC Reconfiguration message, or in step 13 included in a MAC CE message. It is noted that the info/flag: “retain target connection config after SCC (serving cell change, handover) may be forwarded to the UE in step 10 in step 37 included in a MAC CE message.
It is noted that in FIG. 5B steps 23-28 and steps 29-44 can be alternative or optional steps i.e., based on different scenarios when ping pong handling is no longer required or activated. For at least this reason the options in accordance with example embodiments of the invention can include an option 1 with steps 23 to 28 of FIG. 5B or an option 2 with steps 29 to 44 of FIG. 5B.
Release of old source cell and stopping data transmission (CU-UP, old source DU):
DL transmission to former source cell is advantageously not stopped exactly at the reception of indication from target DU, but after source buffer transmission is complete. This is particularly beneficial to avoid PDCP duplicate detection and re-ordering,

A control-PDU based indication from the source DU to the CU-UP indicating residual PDUs are transmitted successfully (timer or packet status based). CU-UP may indicate to CU-CP that source connection can be released based on this indication,
Target DU also report when source cell condition is degraded its request to release source protocol stack (PS). CU-CP takes decision based on indication from CU-UP and Target-DU on releasing the source PS, and.
Source connection can be resumed when there is ping pong.
Cell Indexing:
The CU-CP is proposed to index all the LLM target cell configurations of a UE for easier identification. This is also proposed to be signaled to the CU-UP and the DUs (both serving and target). This ensures that while sending a control-PDU from DU to CU-UP or vice versa, the cell index can be used to identify the DU and cell and determine the NR-CGI of the cell as well.

Please note that cell index may be used to enable the CU-UP to provide the data to the target DU without needing to provide the whole NR-CGI.

None of the above steps may override decisions of CU-CP. If there is a release initiated by CU-CP, it may supersede the CU-UP decision.

In accordance with example embodiments of the invention in step 7 of FIG. 5A the bearer setup request message may include at least one of the following:
Cell ID index (to enable duplication of PDUs, suspend source cell transmission, etc.), and
UE configuration info (with UE supporting simultaneous/parallel data transmission/reception, e.g. indicated by support of DAPS and/or mTRP) to enable duplication of PDUs and parallel transmission of data to different DUs).

The index identifies one out of 8 potential target cells. the 8 (max possible) potential target cell selection is a matter of RRM algorithm at CU-CP. The CU-CP selects the target cells based on the L3 measurements. This may be influenced by the cell size, UE mobility, UE reported RSRP etc. This index can be from a UE perspective. So is unique to the UE. Each UE may have 8 LLM targets and instead of indicating those 8 cells using their NR-CGIs (36-bit identifier), we propose to use an index which just needs 3 bits for 8 values. The CU-CP will send this mapping between the NR-CGI of the LLM target cell and the index when the target cells are configured to the UE. It may be overwritten when required.

If after the cell change from source cell to target cell the UE did not come back to source cell within a timer (needed for ping-pong detection, e.g., 1 s or 3 s), the DU can inform the CU-UP to release the UE context of source cell.

It is noted that at step 20 the ping-pong timer is started, then if timer is expired different process may still follow for handover

It is noted that in an exemplary implementation source and target DU share the same CU-UP (same TEID). This is beneficial as there is no need to relocate PDCP and also no security aspects need to be considered.

In accordance with example embodiments of the invention a value for the timer can correspond with specific local requirements of the network, e.g., a network may monitor the number of ping-pongs occurring locally, e.g., CU to collect number of ping-pongs in controlled cells, then CU can determine a configurable value for the timer to decrease the negative impacts of the ping-pongs, e.g. in areas where high number of ping-pongs occur, e.g. many cell overlaps due to local environment, e.g. many cells in some areas like central station together with constant movement of users, a higher number of ping-pongs may occur and therefore a higher value, e.g., longer duration of the timer, e.g. 3 seconds instead of 1 second might be beneficial. E.g.

in areas where low number of ping-pongs is expected, and/or measured and/or do occur, e.g. few cell overlaps due to local environment, e.g., few cells in some areas like rural areas, side streets, and/or low movement of users (e.g. pedestrians only), a lower number of ping-pongs may occur and therefore a lower value, e.g. shorter duration of the timer, e.g. 1 second instead of 3 seconds might be beneficial. The CU may even decide to set the timer to zero, and/or no to use the special procedure with ease of ping-pong at all, but to follow the legacy procedure. In the legacy procedure the source connection would not be retained post SCC, thus after successful handover the source configuration is released. This happens typically within milliseconds, e.g. 10 to 60 ms. Instead, when using the new procedure with retaining source connection post SCC procedure, the ping-pong timer will be started, so that the retaining time could be extended up to 3 seconds, the ping-pong timer could e.g. be configured to have any value between 1 and 3 seconds, in order to cover a range of a time period within which a potential ping-pong could occur and thus ease handover back to source cell.

Thus, a CU once determining that a target cell needs to be prepared in a DU different from the DU serving the UE checks the situation regarding probability of ping pong from/to target cell and depending on the result (and depending on whether the UE supports the retain source connection post SCC procedure) sets the value of the timer to a lower or higher value or decides not to use the retain source connection post SCC, but to simply cancel the source config after successful handover. This way a fast handover is enabled in case need be and adapted to the local environment and the network and UE capabilities.

Also if reserved resources in CU-UP (reserved for duplication/ping-pong, but not used after successful handover to target DU but no potential ping-pong, for example during 3 seconds, the resources would be reserved but no physical transmission will happen so these are reserved in the network in anticipation that there will be a (potential) ping-pong. In accordance with example embodiments of the invention, resources shall be released once ping-pong is no longer a possibility.

The timer can be required in the DU for at least two purposes; checking if the UE did return back to source cell and releasing of source cell after all the residual PDU's are transmitted. Based on this, if timer expired at step 29 as in FIG. 5B, this causes release of source cell. To be started immediately after step 21 as in FIG. 5B.

In step 22 of FIG. 5B a notification to CU-UP that handover to target DU was successful, but still duplication of data continues (UE still continues to receive data from both source and target DU even after successful handover, e.g., till a certain data buffer is empty, such as for successful transmission of an ongoing video sequence, etc. and/or a ping pong effect is averted (as may be determined based on L1 measurements). Then the duplication will continue until step 26 as in FIG. 5B.

An RRC config complete will not be processed at DU but at CU, the indicated trigger here is to send a notification as soon as RA step completes.

It is noted that FIG. 5B can be adapted to optionally include new step 21a (not shown) send RRC Reconfiguration complete and new step 20b (not shown) send notification to trigger stopping of duplication. As an alternative, if RACH is performed.

UE sending MAC CE in UL may be an indication to DU, but it is not required, since the target DU can simply rely on RACH success.

The duplication is using a control-PDU in step 26 as in FIG. 5B. Further in accordance with example embodiments of the invention the old serving DU can be allowed to indicate to the CU-UP to stop providing data, such as after the buffer is complete (so as to not abruptly stop).

Further, as shown in FIG. 5A and FIG. 5B a second option can apply where a control-PDU may be used, e.g., a “suspend source” stops duplication and thus releases the resources in CU-UP. Further, in an alternative embodiment (not shown in FIG. 5A or FIG. 5B) an additional timer would be required in CU-UP which will release the resources once expired. This timer may be triggered in order to synchronize the timer in the CU-UP with the timer in the target-DU. Then, step 26 as in FIG. 5B would not be needed anymore, but CU-UP will independently perform step 27 and step 28 as in FIG. 5B.

In accordance with example embodiments of the invention if the resources are released based on a timer, a control-PDU would not be required (implicit release). If it is based on source cell radio condition, a control-PDU may be used.

Further, in accordance with example embodiments of the invention, from UE side there is executing parallel reception from source and target cells based on indication from DU. Subsequently, retaining source cell resources for data transmission/reception until explicit indication from DU (avoiding ping-pongs) is also new. It is noted that although there are similarities between this and mTRP, a key difference is that the source cell in a LLM was/is not an assisting cell (as in mTRP). This is purely from a HO perspective and unlike in mTRP, data in source and target cells cannot be different, they have to be duplicate.

In accordance with example embodiments of the invention, there is a UE supporting parallel reception of data from two different DUs, wherein UE is configured to: connect to a first cell of a source DU, receive data from source cell, transmit a measurement report, receive a message including a cell change order towards a second cell of a target DU, the message further including instruction to execute parallel reception from source and target cells, and to retain source cell resources/config for data transmission/reception after cell change to second cell, receive data from second cell, and retain source cell resources and/or configurations.

It is noted that some key differences with L3-based-DAPS can be summarised as below. (And the details of these methods involving new inter-node messages between CU/S-DU/T-DU are specific new methods):
DU triggered dual cell transmission/reception to/at UE with ‘minimum capabilities/features of DAPS but not all the complexities’. For example PDCP at CU-UP can remain unchanged as CU is fixed here for LLM. Objective is interruption free LLM, which is not achievable using DAPS, and
For possible switching to multiple target cells or ping-pong . . . maintaining the source PS part of DAPS in Inactive state instead of releasing the source PS is new aspect. This is also important method to have the interruption reduction for LLM which is expected to have frequent switching across multiple cells. (In DAPS the source PS is released by default on the successful RACH completion to Target. This should not happen for LLM).

### 1. Potential Problem

There is a UP interruption during SCC from Source cell (Cell 1) to Target cell (Cell 3) i.e., from step 14 to step 22 such as in FIG. 4; such delay may be unacceptable for some services like the ones described above.

Indeed, it is possible to eliminate UP interruption, if there is DAPS. But DAPS requires dual receiver chains at the UE and has heavy resource requirements at the network side. It is preferred to have a supplementary feature to overcome the UP-interruption problem with basic UE capabilities (e.g. layer 2 capabilities). The example embodiments of the invention propose a solution to reduce UP-interruption using LLM.

### 2. Potential Problem

Once LLM HO is executed, the CU needs to perform bearer modification so as to enable data transmission to the UE from the Target (now serving) DU.

As may have been mentioned above, DAPS is not a mandatory UE capability. But UP-interruption reduction is valid for non-DAPS UEs as well. For example it could be a UE without any enhanced feature or mTRP UE also. Moreover, LLM permits up to 8 cells and the invention proposes to remember the UE configuration of those cells at the CU-UP, so that in case of ping-pong, the configuration could be activated immediately.

DAPS is a higher layer feature (L3 preparation and execution). Even if we consider a DAPS capable UE and network, preparation of DAPS in 1 target cell is reasonable. To prepare and configure DAPS among 8 cells is very complex and will become an overhead when we are interworking between LLM [symbol] DAPS. DAPS has to be configured before LLM is executed which slows down LLM as well.

Proposals in accordance with example embodiments of the invention can include that the CU-CP notifies the CU-UP about the association between the LLM target cells and the index whenever the target cells are prepared.

Further, it may be assumed that ping-pong refers to switching back and forth between one source cell and one target cell, or is ping-pong between the 8 cells possible. It is noted that ping-pong, by definition is generally only between two cells, but the concept can be extended for more than 2 cells, if desired by the vendor implementation.

### 3. Potential Problem

To the best knowledge of inventors, there is no known prior-art in reducing user-plane interruption during L1 mobility. Example embodiments of the invention address this. This is as DAPS is considered as an overhead and resource consuming expensive feature. Hence not part of the basic feature set in either UE or network. So, cannot be assumed to be a basic solution against UP-interruption.

### 4. Example Embodiments of the Invention Include

Example embodiments of the invention work to address the user-plane interruption issue by complimenting early detection of lower-layer mobility at the source DU and with early data transmission to the target DU. (Features like DAPS and mTRP can also be optionally configured for capable UEs)

As addressed herein, some additional differences to DAPS include:
In case of DAPS the Packet duplication happens at L3 where PDCP is reconfigured for PDCP-DAPS. In the lower layer mobility scenario PDCP remains unaffected,
In DAPS, CU decides the DAPS activation along with Handover command (L3 message) itself. In case of LLM, DU only knows when the switching happens (L2 message), the packet duplication is to be started based on trigger from DU to CU and execution is at DU, and
LLM differs from L3 handover from the perspective of delayed execution based on decision at DU. In such case PDCP duplication for interruption free operation at CU will be redundant and will impact the re-ordering after execution also. Moreover, CU does not even know where to start the packet duplication. So, DU triggered start of dual cell transmission for interruption free LLM is a new aspect compared to basic L3 based DAPS operation.

### Example Embodiments of the Invention Include

To address the ping-pong issue (consecutive forth and back handover to same cells in certain time limit, e.g., 3 seconds) by creating and storing a mapping table at CU-UP to identify the UE and its configuration in a given DU/cell, as long as ping-pong is a possibility. The user configuration may also be retained at the DU during that duration.

In case of a required cell change after successful DAPS handover a new RRC configuration is required to prepare the UE for handover (in case the cell does not belong to the same DU as the serving cell), this required time and additional signaling messages. A way is looked for to reduce the effort for such new handover.

In case of a ping-pong situation, e.g. first DAPS handover from cell 1 of DUI to cell 2 od DU2, and after a successful DAPS handover a second handover back to cell 1 (and back to cell 2, . . . ):

Example embodiments of the invention propose to keep the cell 1 config stored even post a successful first handover for a certain period of time, e.g. 3 seconds. It is assumed that the ping-pong situation can occur for a certain period of time. Thus, it is advantageous to keep the source config even after a successful handover in order to be prepared for a potential ping-pong handover situation and thus enabling a fast handover in a ping-pong situation. This reduces the processing time and leads to higher mobility robustness.

In accordance with example embodiments of the invention a number of ping pongs is reduced. But in case ping-pong has to be triggered (e.g. TTT is e.g. in the range of 20 to 100 ms. The lower the TTT value, the higher the number of required handovers and ping-pongs), then a solution is looked for to perform a fast handover.

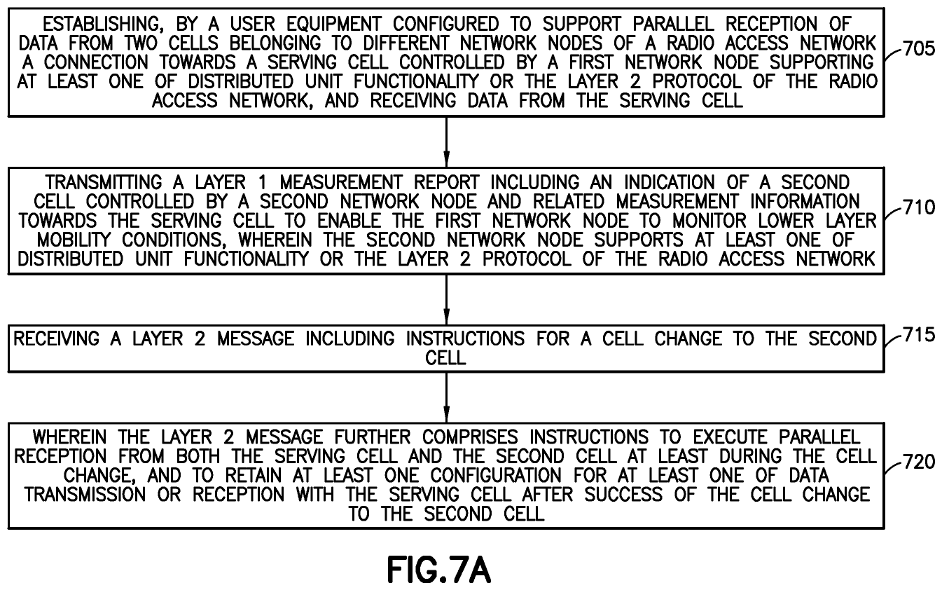

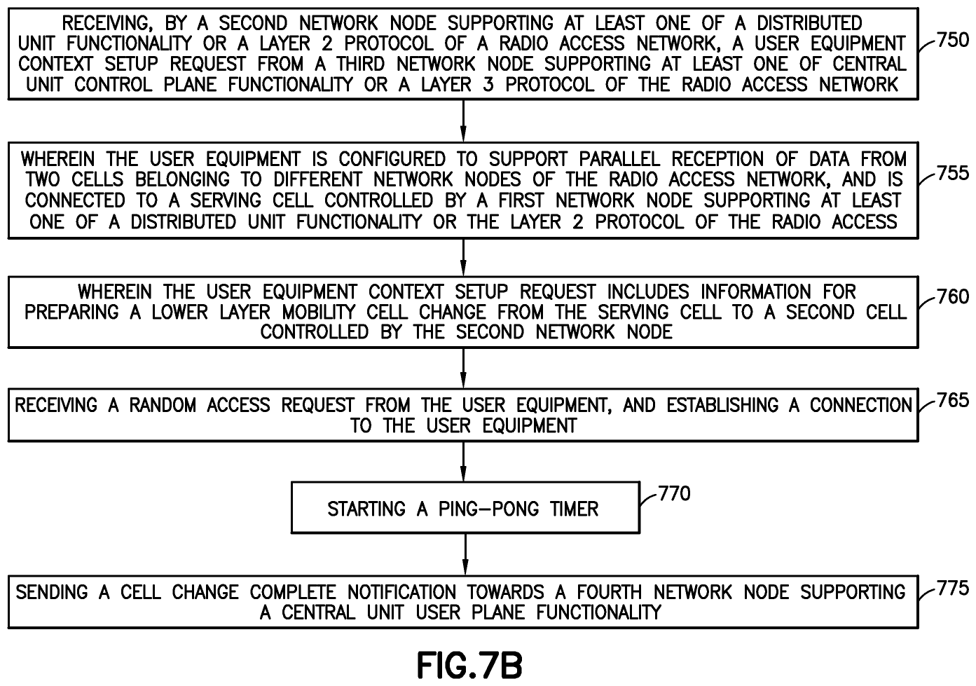

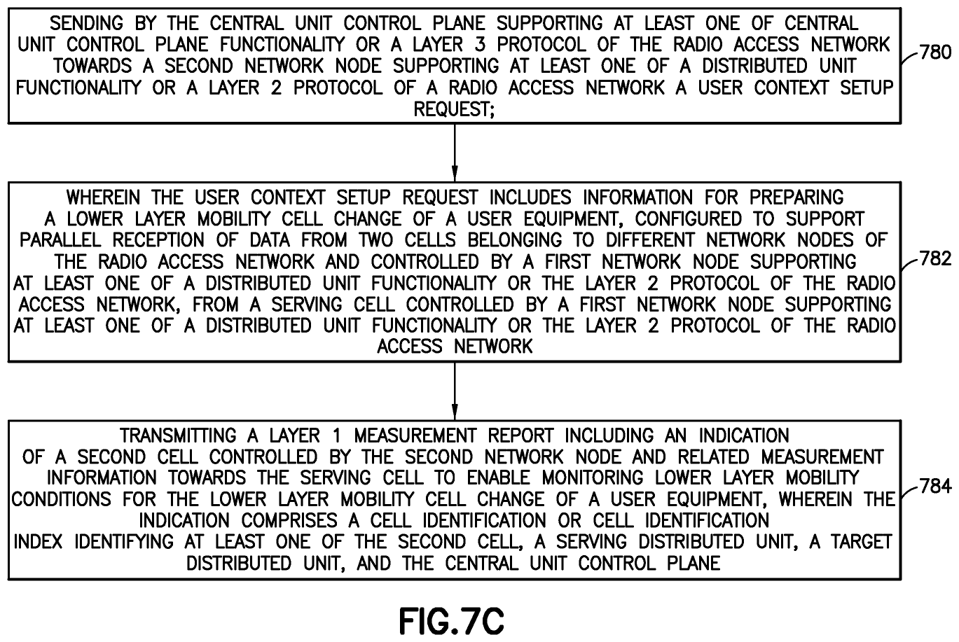

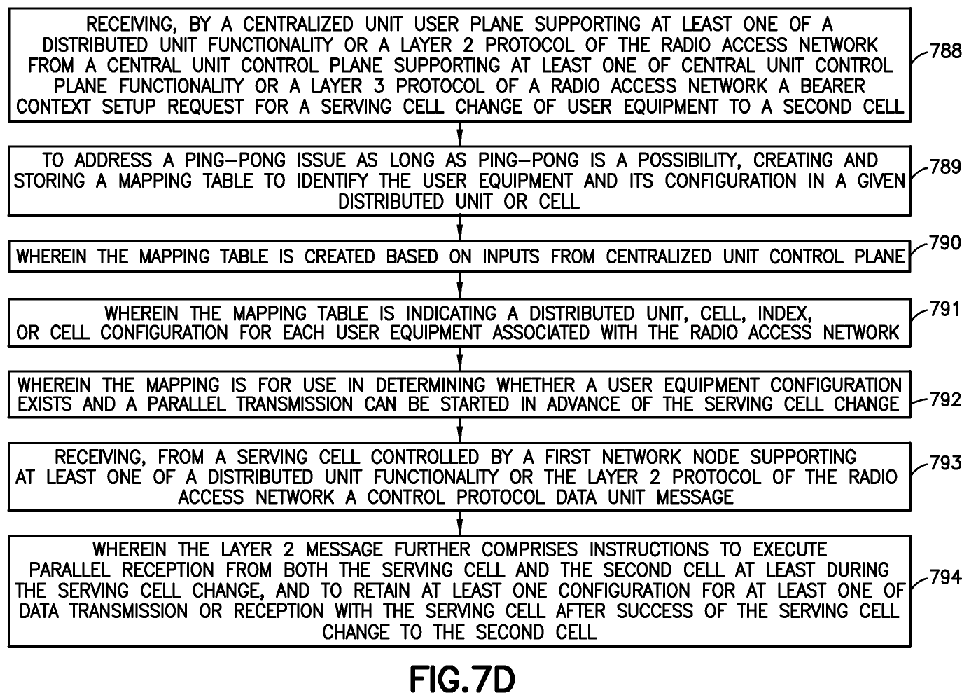

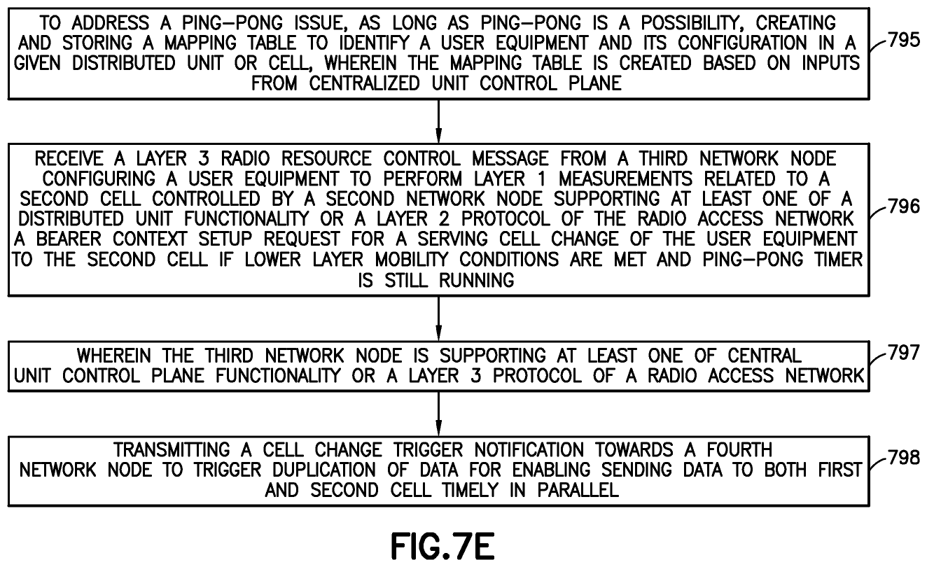

FIG. 7A, FIG. 7B, FIG. 7C, FIG. 7D, and FIG. 7E each show a method in accordance with example embodiments of the invention which may be performed by an apparatus.

FIG. 7A illustrates operations which may be performed by a device such as, but not limited to, a device (e.g., the UE 10 as in FIG. 6). As shown in step 705 of FIG. 7A there is establishing, by a user equipment configured to support parallel reception of data from two cells belonging to different network nodes of a radio access network a connection towards a serving cell supported by a first network node supporting at least one of distributed unit functionality or the layer 2 protocol of the radio access network, and receiving data from the serving cell. As shown in step 710 of FIG. 7A there is transmitting a layer 1 measurement report including an indication of a second cell supported by a second network node and related measurement information towards the serving cell to enable the first network node to monitor lower layer mobility conditions, wherein the second network node supports at least one of distributed unit functionality or the layer 2 protocol of the radio access network. As shown in step 715 of FIG. 7A there is receiving a layer 2 message including instructions for a cell change to the second cell. Then as shown in step 720 of FIG. 7A, wherein the layer 2 message further comprises instructions to execute parallel reception from both the serving cell and the second cell at least during the cell change, and to retain at least one configuration for at least one of data transmission or reception with the serving cell after success of the cell change to the second cell.

In accordance with the example embodiments as described in the paragraph above, wherein the indication comprises a cell identification or cell identification index identifying the second cell.

In accordance with the example embodiments as described in the paragraphs above, wherein the layer 1 measurement report is transmitted using a layer 2 Medium Access Control message.

In accordance with the example embodiments as described in the paragraphs above, wherein the layer 1 measurement report comprises at least one reference signal receive power measurement of the second cell.

In accordance with the example embodiments as described in the paragraphs above, wherein the lower layer mobility refers to layer 2 mobility.

In accordance with the example embodiments as described in the paragraphs above, wherein the layer 2 message is transmitted using a layer 2 Medium Access Control message.

In accordance with the example embodiments as described in the paragraphs above, wherein the monitoring lower layer mobility conditions comprises detection, at the first network node, of a serving cell change requirement based on the receive L1 measurement report.

In accordance with the example embodiments as described in the paragraphs above, wherein there is establishing a connection to the second cell by performing a the random access procedure towards the second cell.

In accordance with the example embodiments as described in the paragraphs above, wherein there is starting a ping-pong timer after the successful cell change to the second cell and retaining the at least one configuration for at least one of data transmission or reception with the serving cell after the successful cell change to the second cell as long as the ping-pong timer is running.

In accordance with the example embodiments as described in the paragraphs above, wherein a value of the ping-pong timer is configurable and received via the radio access network.

In accordance with the example embodiments as described in the paragraphs above, wherein there is, before transmitting the layer 1 measurement report transmitting a layer 3 measurement report including the physical cell ID or an index of the second cell supported by the second network node and related measurement information towards a third network node, wherein the third network node supports at least one of central unit control plane functionality or a layer 3 protocol of the radio access network; and receiving a layer 3 radio resource control message from the third network node configuring the user equipment to perform layer 1 measurements related to the second cell.

In accordance with the example embodiments as described in the paragraphs above, wherein there is, after the successful cell change to the second cell, transmitting a further layer 1 measurement report including an indication of the serving cell and an indication of the a second cell and related measurement information towards the second cell to enable the second network node to monitor lower layer mobility conditions, and receiving a layer 2 message including instructions to suspend at least one of the serving cell transmission or reception.

In accordance with the example embodiments as described in the paragraphs above, wherein there is after the successful cell change to the second cell, transmitting a further layer 1 measurement report including an indication of the serving cell and an indication of the a second cell and related measurement information towards the second cell to enable the second network node to monitor lower layer mobility conditions, and receiving a layer 2 message including instructions for a cell change back to the serving cell, wherein the layer 2 message further comprises instructions to execute parallel reception from both the serving cell and the second cell at least during the cell change, and to retain at least one configuration for at least one of data transmission or reception with the second cell after the successful cell change back to the serving cell.

In accordance with the example embodiments as described in the paragraphs above, wherein there is establishing a connection to the serving cell by performing a the random access procedure towards the serving cell.

In accordance with the example embodiments as described in the paragraphs above, wherein there is starting a timer after the successful cell change to the serving cell and retaining the at least one configuration for at least one of data transmission or reception with the second cell after the successful cell change to the serving cell as long as the timer is running.

In accordance with the example embodiments as described in the paragraphs above, wherein the user equipment is configured to support at least one of multiple transmit receive point and dual active protocol stack capability

A non-transitory computer-readable medium (MEM 10B as in FIG. 6) storing program code (PROG 10C as in FIG. 6), the program code executed by at least one processor (DP 10A and/or DP 10F as in FIG. 6) to perform the operations as at least described in the paragraphs above.

In accordance with an example embodiment of the invention as described above there is an apparatus comprising: means for establishing (TRANS 10D, MEM 10B, PROG 10C, and DP 10A as in FIG. 6), by a user equipment (UE 10 as in FIG. 6) configured to support parallel reception of data from two cells belonging to different network nodes of a radio access network (Network 1 as in FIG. 6) a connection towards a serving cell supported by a first network node (NN 12 or NN 13 as in FIG. 6) supporting at least one of distributed unit functionality or a layer 2 protocol of the radio access network, and means for receiving (TRANS 10D, MEM 10B, PROG 10C, and DP 10A as in FIG. 6) data from the serving cell; means for transmitting (TRANS 10D, MEM 10B, PROG 10C, and DP 10A as in FIG. 6) a layer 1 measurement report including an indication of a second cell supported by a second network node and related measurement information towards the serving cell to enable the first network node to monitor lower layer mobility conditions, wherein the second network node supports at least one of distributed unit functionality or the layer 2 protocol of the radio access network; means for receiving (TRANS 10D, MEM 10B, PROG 10C, and DP 10A as in FIG. 6) a layer 2 message including instructions for a cell change to the second cell, wherein the layer 2 message further comprises instructions (TRANS 10D, MEM 10B, PROG 10C, and DP 10A as in FIG. 6) to execute parallel reception from both the serving cell and the second cell at least during the cell change, and to retain at least one configuration for at least one of data transmission or reception with the serving cell after success of the cell change to the second cell.

In the example aspect of the invention according to the paragraph above, wherein at least the means for establishing, receiving, transmitting, and instructing comprises a non-transitory computer readable medium [MEM 10B as in FIG. 6] encoded with a computer program [PROG 10C as in FIG. 6] executable by at least one processor [DP 10A as in FIG. 6].

FIG. 7B illustrates operations which may be performed by a network device such as, but not limited to, a network node NN 12 or NN 13 as in FIG. 6 or an eNB. As shown in step 750 of FIG. 7B there is receiving, by a second network node supporting at least one of a distributed unit functionality or a layer 2 protocol of a radio access network, a user equipment context setup request from a third network node supporting at least one of central unit control plane functionality or a layer 3 protocol of the radio access network. As shown in step 755 of FIG. 7B wherein the user equipment is configured to support parallel reception of data from two cells belonging to different network nodes of the radio access network, and is connected to a serving cell supported by a first network node supporting at least one of a distributed unit functionality or the layer 2 protocol of the radio access network. As shown in step 760 of FIG. 7B wherein the user equipment context setup request includes information for preparing a lower layer mobility cell change from the serving cell to a second cell supported by the second network node. As shown in step 765 of FIG. 7B there is receiving a random access request from the user equipment, and establishing a connection to the user equipment. As shown in step 770 of FIG. 7B there is starting a ping-pong timer. Then as shown in step 775 of FIG. 7B there is sending a cell change complete notification towards a fourth network node supporting a central unit user plane functionality.

In accordance with the example embodiments as described in the paragraph above, there is receiving, by the second network node, a layer 1 measurement report from the user equipment including an indication of the first and the second cell and related measurement information to enable the second network node to monitor lower layer mobility conditions; monitoring whether ping-pong timer is still running; transmitting a layer 2 message including instructions for a cell change towards the user equipment if lower layer mobility conditions are met and ping-pong timer is still running, the layer 2 message comprising instructions for a cell change back to the serving cell, wherein the layer 2 message further comprises instructions to execute parallel reception from both the serving cell and the second cell at least during the cell change, and to retain at least one configuration for at least one of data transmission or reception with the second cell after the successful cell change back to the serving cell; and transmitting a cell change trigger notification towards the fourth network node to trigger duplication of data for enabling sending data to both first and second cell timely in parallel.

In accordance with the example embodiments as described in the paragraphs above, wherein the indication comprises a cell identification or cell identification index identifying the second cell.

In accordance with the example embodiments as described in the paragraphs above, there is retaining at least one configuration for at least one of data transmission or reception with the serving cell after the successful cell change to the second cell as long as the ping-pong timer is running.

In accordance with the example embodiments as described in the paragraphs above there is receiving, by the second network node, a layer 1 measurement report from the user equipment including an indication of the first and the second cell and related measurement information to enable the second network node to monitor lower layer mobility conditions, monitoring whether ping-pong timer is still running; transmitting a layer 2 message including instructions to suspend serving cell transmissions if lower layer mobility conditions are not met and ping-pong timer is still running or if ping-pong timer expired; and transmitting a suspend cell trigger notification towards the fourth network node to trigger stopping of duplication of data for suspending sending data to both first and second cell timely in parallel.

In accordance with the example embodiments as described in the paragraphs above, there is monitoring whether ping-pong timer is still running; and if ping-pong timer expired, transmitting a suspend serving cell trigger notification towards the fourth network node to trigger stopping of duplication of data for suspending sending data to both first and second cell timely in parallel.

In accordance with the example embodiments as described in the paragraphs above, there is receiving an indication comprising a measurement report from the user equipment; and based on the indication initiate duplicate transmission of packets at the fourth network node.

In accordance with the example embodiments as described in the paragraphs above, wherein the initiation is based on radio resource management defined thresholds for the measurement report.

In accordance with the example embodiments as described in the paragraphs above, wherein there is receiving from the user equipment a layer 1 measurement report; and based on the receiving, sending towards the user equipment a medium access control control element indicating the cell change.

A non-transitory computer-readable medium (MEM 12B and/or MEM 13B as in FIG. 6) storing program code (PROG 12C and/or PROG 13C as in FIG. 6), the program code executed by at least one processor (DP 12A and/or DP 13A as in FIG. 6) to perform the operations as at least described in the paragraphs above.

In accordance with an example embodiment of the invention as described above there is an apparatus comprising: means for receiving (TRANS 12D and/or TRANS 13D, MEM 12B and/or MEM 13B, PROG 12C and/or PROG 13C, and DP 12A and/or DP 13A as in FIG. 6), by a second network node (NN 12 and/or NN 13 as in FIG. 6) supporting at least one of a distributed unit functionality or a layer 2 protocol of a radio access network (Network 1 as in FIG. 6), a user equipment (UE 10 as in FIG. 6) context setup request from a third network node supporting at least one of central unit control plane functionality or a layer 3 protocol of the radio access network, wherein the user equipment is configured to support parallel reception of data from two cells belonging to different network nodes of the radio access network, and is connected to a serving cell supported by a first network node supporting at least one of a distributed unit functionality or the layer 2 protocol of the radio access network, wherein the user equipment context setup request (TRANS 12D and/or TRANS 13D, MEM 12B and/or MEM 13B, PROG 12C and/or PROG 13C, and DP 12A and/or DP 13A as in FIG. 6) includes information for preparing a lower layer mobility cell change from the serving cell to a second cell supported by the second network node; means for receiving (TRANS 12D and/or TRANS 13D, MEM 12B and/or MEM 13B, PROG 12C and/or PROG 13C, and DP 12A and/or DP 13A as in FIG. 6) a random access request from the user equipment, and establishing a connection to the user equipment; means for starting (TRANS 12D and/or TRANS 13D, MEM 12B and/or MEM 13B, PROG 12C and/or PROG 13C, and DP 12A and/or DP 13A as in FIG. 6) a ping-pong timer; and means for sending (TRANS 12D and/or TRANS 13D, MEM 12B and/or MEM 13B, PROG 12C and/or PROG 13C, and DP 12A and/or DP 13A as in FIG. 6) a cell change complete notification towards a fourth network node supporting a central unit user plane functionality.

In the example aspect of the invention according to the paragraph above, wherein at least the means for establishing, receiving, requesting, starting, and sending comprises a non-transitory computer readable medium [MEM 12B and/or MEM 13B as in FIG. 6] encoded with a computer program [PROG 12C and/or PROG 13C as in FIG. 6] executable by at least one processor [DP 12A and/or DP 13A as in FIG. 6].

FIG. 7C illustrates operations which may be performed by a network device such as, but not limited to, a central unit control plane as described herein. As shown in step 780 of FIG. 7C there is sending by the central unit control plane supporting at least one of central unit control plane functionality or a layer 3 protocol of the radio access network towards a second network node supporting at least one of a distributed unit functionality or a layer 2 protocol of a radio access network a user context setup request. As shown in step 782 of FIG. 7C wherein the user context setup request includes information for preparing a lower layer mobility cell change of a user equipment, configured to support parallel reception of data from two cells belonging to different network nodes of the radio access network and controlled by a first network node supporting at least one of a distributed unit functionality or the layer 2 protocol of the radio access network, from a serving cell controlled by a first network node supporting at least one of a distributed unit functionality or the layer 2 protocol of the radio access network. Then as shown in step 784 of FIG. 7C there is transmitting a layer 1 measurement report including an indication of a second cell controlled by the second network node and related measurement information towards the serving cell to enable monitoring lower layer mobility conditions for the lower layer mobility cell change of a user equipment, wherein the indication comprises a cell identification or cell identification index identifying at least one of the second cell, a serving distributed unit, a target distributed unit, and the central unit control plane.

FIG. 7D illustrates operations which may be performed by a central unit control plane as described herein. As shown in step 788 of FIG. 7D there is receiving, by the centralized unit user plane supporting at least one of a distributed unit functionality or a layer 2 protocol of a radio access network from a central unit control plane supporting at least one of central unit control plane functionality or a layer 3 protocol of the radio access network a bearer context setup request for a serving cell change of user equipment to a second cell. As shown in step 789 of FIG. 7D there is, to address a ping-pong issue as long as ping-pong is a possibility, creating and storing a mapping table to identify the user equipment and its configuration in a given distributed unit or cell. As shown in step 790 of FIG. 7D wherein the mapping table is created based on inputs from centralized unit control plane. As shown in step 791 of FIG. 7D wherein the mapping table is indicating a distributed unit, cell, index, or cell configuration for each user equipment associated with the radio access network. As shown in step 792 of FIG. 7D wherein the mapping is for use in determining whether a user equipment configuration exists and a parallel transmission can be started in advance of the serving cell change. As shown in step 790 of FIG. 7D there is receiving, from a serving cell controlled by a first network node supporting at least one of a distributed unit functionality or the layer 2 protocol of the radio access network a control protocol data unit message. Then as shown in step 794 of FIG. 7D wherein the layer 2 message further comprises instructions to execute parallel reception from both the serving cell and the second cell at least during the serving cell change, and to retain at least one configuration for at least one of data transmission or reception with the serving cell after success of the serving cell change to the second cell.

FIG. 7E illustrates operations which may be performed by a serving distributed unit as described herein. As shown in step 795 of FIG. 7E there is, to address a ping-pong issue as long as ping-pong is a possibility, creating and storing a mapping table to identify a user equipment and its configuration in a given distributed unit or cell, wherein the mapping table is created based on inputs from centralized unit control plane. As shown in step 796 of FIG. 7E there is receiving a layer 3 radio resource control message from a third network node configuring a user equipment to perform layer 1 measurements related to a second cell controlled by a second network node supporting at least one of a distributed unit functionality or a layer 2 protocol of the radio access network a bearer context setup request for a serving cell change of the user equipment to the second cell if lower layer mobility conditions are met and ping-pong timer is still running. As shown in step 797 of FIG. 7E wherein the third network node is supporting at least one of central unit control plane functionality or a layer 3 protocol of a radio access network. Then as shown in step 798 of FIG. 7E there is transmitting a cell change trigger notification towards a fourth network node to trigger duplication of data for enabling sending data to both first and second cell timely in parallel.

### Advantages:

If source connection is retained during this serving cell change duration, UE can receive simultaneously from both serving and target cell leading to almost zero user-interruption time. Some features of mTRP or DAPS could be re-used here.

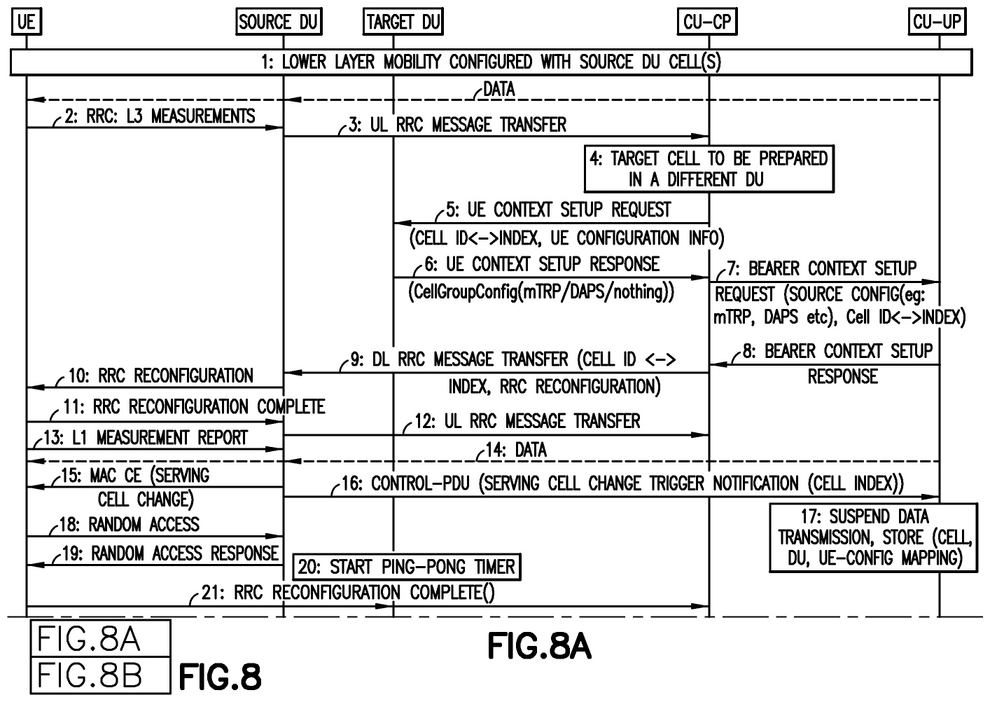

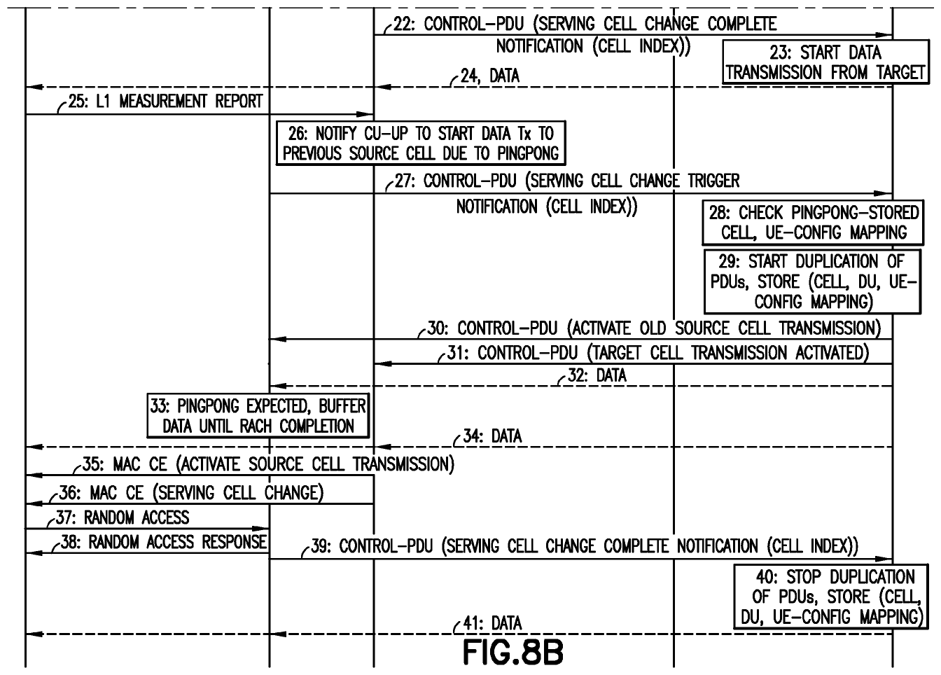

FIG. 8 relates to still another embodiment showing the signaling flow of a UE undergoing inter-DU LLM with pingpongs, but without mRTP/DAPS being configured. Note that the user-plane interruption is reduced even in case of a UE without simultaneous reception capability (e.g.: as in mTRP) or without simultaneous reception capability being activated or used (e.g. not using simultaneous reception although potentially possible might be due to load conditions, contractual reasons, or source DU and/or target DU not supporting or not activating mTRP, or other reasons) as the mapping and configuration of the previous serving cell (/DU) is stored at CU-UP (expecting a pingpong) and hence data transmission is started earlier compared to state-of-the-art. There are no resource reservation issues that may be associated with target LLM cells as the CU-UP remembers the previous serving cell and its configuration at least when the ping-pong timer is running.

In FIG. 5B at step 24, the pingpong was averted and timer expiry led to suspension of data transmission to the source cell. In FIG. 8 at step 26, pingpong is detected before timer expiry. Hence the transmission to old serving cell (source cell) is started: step 30 activate old source cell, step 32 receive data at source cell, step 33 buffer/store received data even before UE starts sending random access, step 37 receive random access at source cell, step 38 send random access response, step 41 send to UE buffered data and new data.

A user equipment of FIG. 8 might be configured in the following way: A UE, comprising:
at least one processor; and
at least one non-transitory memory including computer program code, where the at least one non-transitory memory and the computer program code are configured, with the at least one processor, to cause the user equipment to at least:
establish, by the user equipment configured to support reception of data from a network node of a radio access network, a connection towards a serving (source) cell controlled by a first network node supporting at least one of distributed unit functionality or the layer 2 protocol of the radio access network, and receiving data from the serving cell;
transmit a layer 1 measurement report including an indication of a second cell controlled by a second network node and related measurement information towards the serving cell to enable the first network node to monitor lower layer mobility conditions, wherein the second network node supports at least one of distributed unit functionality or the layer 2 protocol of the radio access network; and
receive a layer 2 message including instructions for a cell change to the second cell, wherein the layer 2 message further comprises instructions to retain at least one configuration for at least one of data transmission or reception with the serving cell after success of the cell change to the second cell.
   The UE is configured to start a ping-pong timer after the successful cell change to the second cell and retain the at least one configuration for at least one of data transmission or reception with the serving cell after the successful cell change to the second cell as long as the ping-pong timer is running.
   The user equipment advantageously receives the value of the pingpong timer via the radio access network, e.g. together with the layer 2 message (or in a separate message), wherein the value of the ping-pong timer is configurable.
   In case of the occurrence of a pingpong, e.g. after provision of a L1 measurement report to the second cell, the UE receives a layer 2 message including instructions for a cell change back to the source cell,
wherein the layer 2 message further comprises instructions to retain at least one configuration for at least one of data transmission or reception with the serving (target, second) cell after success of the cell change back to the source cell.

The UE is configured to start a ping-pong timer after the successful cell change to the source cell and retain the at least one configuration for at least one of data transmission or reception with the target cell after the successful cell change to the source cell as long as the ping-pong timer is running.

Parts of FIG. 5A, 5B and 8 (e.g. single or multiple messages, reports, instructions, etc.) might be combined to e.g. enrich the respective other Fig. and its operation and messages flows, and/or to generate a new embodiment.

The following description may provide further details of alternatives, modifications and variances: a gNB comprises e.g. a node providing NR user plane and control plane protocol terminations towards the UE, and connected via the NG interface to the 5GC, e.g. according to 3GPP TS 38.300 V16.6.0 (2021 June) section 3.2 incorporated by reference.

A gNB Central Unit (gNB-CU) comprises e.g. a logical node hosting e.g. RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g. a logical node hosting e.g. RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g. a logical node hosting e.g. the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g. according to 3GPP TS 38.401 V16.6.0 (2021 July) section 3.1 incorporated by reference.

Different functional splits between the central and distributed unit are possible, e.g. called options:
Option 1 (1A-like split):
   The function split in this option is similar to the 1A architecture in DC. RRC is in the central unit. PDCP, RLC, MAC, physical layer and RF are in the distributed unit.
Option 2 (3C-like split):
   The function split in this option is similar to the 3C architecture in DC. RRC and PDCP are in the central unit. RLC, MAC, physical layer and RF are in the distributed unit.
Option 3 (intra RLC split):
   Low RLC (partial function of RLC), MAC, physical layer and RF are in the distributed unit. PDCP and high RLC (the other partial function of RLC) are in the central unit.
Option 4 (RLC-MAC split):
   MAC, physical layer and RF are in the distributed unit. PDCP and RLC are in the central unit.
Or else, e.g. according to 3GPP TR 38.801 V14.0.0 (2017 March) section 11 incorporated by reference.

A gNB supports different protocol layers, e.g. Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:

The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. to segmentation;
Control channels include (BCCH, PCCH).

Layer 3 (L3) includes e.g. Radio Resource Control (RRC), e.g. according to 3GPP TS 38.300 V16.6.0 (2021 June) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3.

The gNB CU and gNB DU parts may e.g. be co-located or physically separated. The gNB DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

A gNB-DU supports one or multiple cells, and could thus serve as e.g. a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0 (2021 June) sections 42.1 and 4.4, incorporated by reference).

A UE is e.g. either in RRC_CONNECTED state or in RRC_INACTIVE state when an RRC connection has been established.

In RRC CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting;

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

According to 3GPP TS 23.501 v17.4.0 (2022 March) the 5G System architecture is defined to support data connectivity and services enabling deployments to use techniques such as e.g. Network Function Virtualization and Software Defined Networking. The 5G System architecture shall leverage service-based interactions between Control Plane (CP) Network Functions where identified. Some key principles and concepts are to: a) separate the User Plane (UP) functions (UPF) from the Control Plane (CP) functions, allowing independent scalability, evolution and flexible deployments e.g. centralized location or distributed (remote) location, b) modularize the function design, e.g. to enable flexible and efficient network slicing, c) wherever applicable, define procedures (i.e. the set of interactions between network functions) as services, so that their re-use is possible, and d) enable each Network Function (NF) and its Network Function Services to interact with another NF and its Network Function Services directly or indirectly via a Service Communication Proxy if required. The architecture does not preclude the use of another intermediate function to help route Control Plane messages (e.g. like a DRA).

A user plane in this patent spec may e.g. support one or more of the UPFs and/or user plane connections listed in the above TS23.501 (and/or future versions thereof) in one or more architectures and may be implemented using e.g. one or more processors, and/or one or more memories, and/or router(s) and/or software module(s) and/or firmware, and/or switch(es) and/or user plane means and/or user plane node(s).

UPF provides e.g. the interconnect point between the mobile infrastructure and the Data Network (DN), i.e. encapsulation and decapsulation of a GPRS Tunneling Protocol for the user plane (GTP U).

The Protocol Data Unit (PDU) session is an anchor point for providing mobility within and between Radio Access Technologies (RATs), including sending one or more end marker packets to the gNB.

User Plane Function(s) handle the user plane path of PDU Sessions. 3GPP specifications support deployments with a single UPF or multiple UPFs for a given PDU Session. UPF selection is performed by the SMF. The details of UPF selection is described in clause 6.3.3. The number of UPFs supported for a PDU Session is unrestricted.

Regarding FIG. 5A and FIG. 5B different messages currently defines in the 3GPP standards may need some modifications to include the above inventive features, e.g. regarding step 5 TS38.473 v17.0.0 (2022 April, e.g. Sec. 8.3.1 and 9.2.2.1 (included by reference may need some modification(s) to enable ping-pong supported handover operation, e.g. step 5 of FIG. 5A:

The UE context setup request message may include at least one of the following:
Cell ID index (to enable triggering of duplication of PDUs, suspend source cell transmission, etc.),
UE configuration info (with info/flag: “retain source connection config after SCC (serving cell change, handover) (->to be forwarded to UE in case of handover to target DU)

Step 5 is preparation of target cell in target DU. Hence it has to be from CU-CP to target DU.

The UE context setup with source DU is assumed to have already occurred in step 1.

Regarding step 7 message and fields which may need modification (CU-CP-CU-UP interface E1): TS37.483 v17.0.0 (2022 April), e.g. Sec. 8.3.1 and 9.2.2.1 (included by reference). The above sections may need some modification(s) to enable ping-pong supported handover operation, e.g.

Step 7 of FIG. 5A: The bearer setup request message may include at least one of the following:
Cell ID index (to enable duplication of PDUs, suspend source cell transmission, etc.).
UE configuration info (with UE supporting simultaneous/parallel data transmission/reception, e.g. indicated by support of DAPS and/or mTRP) to enable duplication of PDUs and parallel transmission of data to different DUs).

Step 15 message and fields which may need modification (CU-UP-DU interface F1-U): TS38.470 and TS38.475. Further layer 2 (e.g. MAC CE) and layer 3 (e.g. RRC) messages may need some modifications, e.g. including information related to at least one of: cell ID, flag: retain source config post SCC, etc.). This may relate to TS38.331, TS38.300, and/or TS38.321, if e.g. referred to 5G, and if e.g. referred to LTE respective TS36.xxx specs.

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-53. (canceled)

54. A method, comprising:
establishing, by a user equipment configured to support parallel transmission and/or reception of data from two different cells belonging to different network nodes of a radio access network, a connection towards a serving cell controlled by a first network node supporting at least one of distributed unit functionality or the layer 2 protocol of the radio access network, and receiving data from the serving cell;
transmitting a layer 1 measurement report including an indication of a second cell controlled by a second network node and related measurement information towards the serving cell to enable the first network node to monitor lower layer mobility conditions, wherein the second network node supports at least one of distributed unit functionality or the layer 2 protocol of the radio access network; and
receiving a layer 2 message including instructions for a serving cell change to the second cell,
wherein the layer 2 message further comprises instructions to execute at least one of parallel reception or transmission from both the serving cell and the second cell at least during the serving cell change, and to retain at least one of connection or configuration for at least one of data transmission or reception with the serving cell after successful serving cell change to the second cell.

55. The method of claim 54, wherein the indication comprises a cell identification or cell identification index identifying the second cell.

56. The method of claim 54, wherein the layer 1 measurement report is transmitted using a layer 2 Medium Access Control message.

57. The method of claim 54, wherein the layer 1 measurement report comprises at least one reference signal receive power measurement of the second cell.

58. The method of claim 54, wherein the lower layer mobility refers to layer 1/2 mobility.

59. The method of claim 54, wherein the layer 2 message is transmitted using a layer 2 Medium Access Control message.

60. The method of claim 54, wherein the monitoring lower layer mobility conditions comprises detection, at the first network node, of a serving cell change requirement based on the layer 1 measurement report.

61. The method of claim 54, wherein the method further comprises:
establishing a connection to the second cell by performing a the random access procedure towards the second cell.

62. The method of claim 54, wherein the method further comprises:
starting a ping-pong timer after the successful serving cell change to the second cell and retaining the at least one connection and/or configuration for at least one of data transmission or reception with the serving cell after the successful cell change to the second cell as long as the ping-pong timer is running.

63. The method of claim 62, wherein a value of the ping-pong timer is configurable and received via the radio access network air interface.

64. The method of claim 54, wherein the method further comprises:
before transmitting the layer 1 measurement report transmitting a layer 3 measurement report including the physical cell ID or an index of the second cell controlled by the second network node and related measurement information towards a third network node, wherein the third network node supports at least one of central unit control plane functionality or a layer 3 protocol of the radio access network; and
receiving a layer 3 radio resource control message from the third network node configuring the user equipment to perform layer 1 measurements related to the second cell.

65. The method of claim 54, wherein the method further comprises, after the successful cell change to the second cell, transmitting a further layer 1 measurement report including an indication of the serving cell and an indication of the a second cell and related measurement information towards the second cell to enable the second network node to monitor lower layer mobility conditions, and receiving a layer 2 message including instructions to suspend at least one of the serving cell transmission or reception.

66. The method of claim 54, wherein the method further comprises:
after the successful cell change to the second cell, transmitting a further layer 1 measurement report including an indication of the serving cell and an indication of the a second cell and related measurement information towards the second cell to enable the second network node to monitor lower layer mobility conditions, and
receiving a layer 2 message including instructions for a cell change back to the serving cell, wherein the layer 2 message further comprises instructions to execute parallel reception from both the serving cell and the second cell at least during the cell change, and to retain at least one configuration for at least one of data transmission or reception with the second cell after the successful cell change back to the serving cell.

67. The method of claim 66, wherein the method further comprises, establishing a connection to the serving cell by performing a the random access procedure towards the serving cell.

68. The method of claim 54, wherein the method further comprises:
starting a timer to monitor ping-pong, after the successful cell change to the serving cell and retaining the at least one configuration for at least one of data transmission or reception with the second cell after the successful cell change to the serving cell as long as the timer is running.

69. The method of claim 54, wherein the user equipment is configured to support at least one of multiple transmission reception point and dual active protocol stack capability.

70. A user equipment, comprising:
at least one processor; and
at least one non-transitory memory including computer program code, where the at least one non-transitory memory and the computer program code are configured, with the at least one processor, to cause the user equipment to at least:
establish, by the user equipment configured to support parallel reception of data from two different cells belonging to different network nodes of a radio access network, a connection towards a serving cell controlled by a first network node supporting at least one of distributed unit functionality or the layer 2 protocol of the radio access network, and receiving data from the serving cell;
transmit a layer 1 measurement report including an indication of a second cell controlled by a second network node and related measurement information towards the serving cell to enable the first network node to monitor lower layer mobility conditions, wherein the second network node supports at least one of distributed unit functionality or the layer 2 protocol of the radio access network; and
receive a layer 2 message including instructions for a cell change to the second cell, wherein the layer 2 message further comprises instructions to execute parallel reception from both the serving cell and the second cell at least during the cell change, and to retain at least one configuration for at least one of data transmission or reception with the serving cell after success of the cell change to the second cell.

71. The user equipment of claim 70, wherein the indication comprises a cell identification or cell identification index identifying the second cell.

72. The user equipment of claim 70, wherein the layer 1 measurement report is transmitted using a layer 2 Medium Access Control message.

73. The user equipment of claim 70, wherein the layer 1 measurement report comprises at least one reference signal receive power measurement of the second cell.

74. The user equipment of claim 70, wherein the lower layer mobility refers to layer 2 mobility.

75. The user equipment of claim 70, wherein the layer 2 message is transmitted using a layer 2 Medium Access Control message.

76. The user equipment of claim 70, wherein the monitoring lower layer mobility conditions comprises detection, at the first network node, of a serving cell change requirement based on the received layer 1 measurement report.

77. The user equipment of claim 70, wherein the at least one non-transitory memory including the computer program code is configured with the at least one processor to cause the user equipment to:
establish a connection to the second cell by performing a the random access procedure towards the second cell.

78. The user equipment of claim 70, wherein the at least one non-transitory memory including the computer program code is configured with the at least one processor to cause the user equipment to:
start a ping-pong timer after the successful cell change to the second cell and retain the at least one configuration for at least one of data transmission or reception with the serving cell after the successful cell change to the second cell as long as the ping-pong timer is running.

79. The user equipment of claim 78, wherein a value of the ping-pong timer is configurable and received via the radio access network.

80. The user equipment of claim 70, wherein the at least one non-transitory memory including the computer program code is configured with the at least one processor to cause the user equipment to:
before transmitting the layer 1 measurement report transmit a layer 3 measurement report including the physical cell ID or an index of the second cell controlled by the second network node and related measurement information towards a third network node, wherein the third network node supports at least one of central unit control plane functionality or a layer 3 protocol of the radio access network; and
receive a layer 3 radio resource control message from the third network node configuring the user equipment to perform layer 1 measurements related to the second cell.

81. The user equipment of claim 70, wherein the at least one non-transitory memory including the computer program code is configured with the at least one processor to cause the user equipment to:
after the successful cell change to the second cell, transmit a further layer 1 measurement report including an indication of the serving cell and an indication of the a second cell and related measurement information towards the second cell to enable the second network node to monitor lower layer mobility conditions, and
receive a layer 2 message including instructions to suspend at least one of the serving cell transmission or reception.

82. The user equipment of claim 70, wherein the at least one non-transitory memory including the computer program code is configured with the at least one processor to cause the user equipment to:
after the successful cell change to the second cell, transmit a further layer 1 measurement report including an indication of the serving cell and an indication of the a second cell and related measurement information towards the second cell to enable the second network node to monitor lower layer mobility conditions; and
receive a layer 2 message including instructions for a cell change back to the serving cell, wherein the layer 2 message further comprises instructions to execute parallel reception from both the serving cell and the second cell at least during the cell change, and to retain at least one configuration for at least one of data transmission or reception with the second cell after the successful cell change back to the serving cell.

83. The user equipment of claim 82, wherein the at least one non-transitory memory including the computer program code is configured with the at least one processor to cause the user equipment to:
establish a connection to the serving cell by performing a the random access procedure towards the serving cell.

84. The user equipment of claim 70, wherein the at least one non-transitory memory including the computer program code is configured with the at least one processor to cause the user equipment to:
start a timer after the successful cell change to the serving cell and retaining the at least one configuration for at least one of data transmission or reception with the second cell after the successful cell change to the serving cell as long as the timer is running.

85. The user equipment of claim 70, wherein the user equipment maybe configured to support at least one of multiple transmission reception point and dual active protocol stack capability.

86. A second network node comprising:
at least one processor; and
at least one non-transitory memory including computer program code, where the at least one non-transitory memory and the computer program code are configured, with the at least one processor, to cause the second network node to at least:
receive, by a second network node supporting at least one of a distributed unit functionality or a layer 2 protocol of a radio access network, a user equipment context setup request from a third network node supporting at least one of central unit control plane functionality or a layer 3 protocol of the radio access network,
wherein the user equipment is configured to support parallel reception of data from two cells belonging to different network nodes of the radio access network, and is connected to a serving cell controlled by a first network node supporting at least one of a distributed unit functionality or the layer 2 protocol of the radio access network, and
wherein the user equipment context setup request includes information for preparing a lower layer mobility cell change from the serving cell to a second cell controlled by the second network node;
receive a random access request from the user equipment, and establishing a connection to the user equipment;
start a ping-pong timer; and
send a cell change complete notification towards a fourth network node supporting a central unit user plane functionality.

87. The second network node of claim 86, wherein the at least one non-transitory memory including the computer program code is configured with the at least one processor to cause the second network node to:
receive, by the second network node, a layer 1 measurement report from the user equipment including an indication of the first and the second cell and related measurement information to enable the second network node to monitor lower layer mobility conditions;
monitor whether ping-pong timer is still running;
transmit a layer 2 message including instructions for a cell change towards the user equipment if lower layer mobility conditions are met and ping-pong timer is still running, the layer 2 message comprising instructions for a cell change back to the serving cell, wherein the layer 2 message further comprises instructions to execute parallel reception from both the serving cell and the second cell at least during the cell change, and to retain at least one configuration for at least one of data transmission or reception with the second cell after the successful cell change back to the serving cell, and
transmit a cell change trigger notification towards the fourth network node to trigger duplication of data for enabling sending data to both first and second cell timely in parallel.
